(19) United States
(12) Patent Application Publication
(10) Pub. No.: US 2003/0184893 A1
(43) Pub. Date: Oct. 2, 2003

(54) Multi-layer mirror and fabricating method thereof

(75) Inventors: Tung-Kuei Lu, Hualien (TW); Wei-Hsiang Wang, Taipei (TW)

Correspondence Address: Quintero Law Office, 1617 Broadway, 3rd Floor, Santa Monica, CA, 90404, US

(73) Assignee: Ritek Corporation

(21) Appl. No.: 10/400,957

(22) Filed: Mar. 27, 2003

(30) Foreign Application Priority Data
Mar. 29, 2002 (TW) 91106449

(51) Int. Cl. G02B 5/08; G02B 7/182

(52) U.S. Cl. 359/883

(57) ABSTRACT

A multi-layer mirror and the fabricating method thereof. The mirror is applicable for manufacture of micro-cavities in light emitting devices. The method of fabricating the multi-layer mirror includes sputtering a first-layer mirror with a first refractive index on a transparent substrate of a light-emitting device using a first reactive gas, sputtering a second-layer mirror with a second refractive index using a second reactive gas, and repeating the previous two steps to form a multi-layer mirror having at least two adjacent layers with various refractive indices.

### BACKGROUND OF THE INVENTION

1. Field of the Invention

The present invention relates to a multi-layer mirror and fabricating method thereof, and more particularly to a method able to fabricate a multi-layer mirror having two adjacent layers of different refractive indices with a single target under reactive gases of different concentrations or species.

2. Description of the Related Art

Organic light emitting diode (OLED) is divided into two groups, small molecular organic light emitting diode (SMOLED) and polymer organic light emitting diode (Polymer OLED, PLED), distinguished by the type of organic film thereof. Organic films of SMOLED are made of organic compounds while those of Polymer OLED are made of conjugated polymers.

The SMOLED/PLED is analogous to that of conventional light-emitting diodes in terms of the working principle. Light emission is accomplished through the recombination of electrons and holes from the cathode and anode, respectively. Dependent on the device structure, a typical OLED has a hole transport layer, emitting material layer, and electron transport layer between the electrodes. Current through the device excites the electrons to higher energy states, and their relaxation to lower states results in light emission with the wavelengths dependent on the organic materials and device structure used. In addition, dopant emitter materials can be added to increase the light-emitting efficiency and expand the scope of wavelengths of emitted light to all visible light ranges.

Light is a form of energy. The three primary colors of light are red, green and blue. The wavelengths of red, green and blue light are around 6000 Å, 5500 Å, and 4650 Å, respectively. Red light has relatively longer wavelength and results in less scattering while blue light has relatively shorter wavelength and results in more scattering. Owing to the shortcomings of short-wavelength light's increased scattering, the light-emitting efficiency of OLED is low, thus demanding improvement.

To solve the above-mentioned problem from anisotropy of light, numerous light-emitting devices have been presented having various structures to enhance light-emitting efficiency. One of the structures is “microcavity”, able to guide and enhance the resonance of specific light to emit toward the surface of the device. In a micro-cavity, a multi-layer mirror is positioned between a substrate and a conductive layer to shift the optical phase of part of the emitted light and thereby enhance specific light by resonance.

One conventional fabricating method of multi-layer mirrors is evaporation, wherein SiO₂ and SiₓN_{y} are evaporated onto the substrate in turn, and the optical phase of emitted-light is shifted thereby as a result of the different refractive indices thereof, thus enhancing the light emission. For further related art, please refer to U.S. Pat. No. 5,405,710, U.S. Pat. No. 5,814,416 and U.S. Pat. No. 6,278,236.

Evaporation is a process to vaporize metal into metal vapor in vacuum, and to condense the metal vapor on a substrate into a film. The material of the substrate is not limited, and paper, metal, and ceramic material are all applicable. Though there are various choices for the target, the too-slow rate of film formation makes evaporation not suitable for mass production.

Sputtering is another vacuum process used to deposit thin films on substrates for a wide variety of commercial and scientific purposes. Modern sputtering (magnetron sputtering) uses powerful magnets to confine “glow discharge” plasma to a region closest to a target plate, vastly improving the deposition rate by maintaining a higher density of ions, which makes the electron/gas molecule collision process much more efficient. Generally, DC magnetron sputtering is applied to metal substrates, while radio frequency sputtering (RF sputtering) is applied to insulating substrates, such as ceramics.

To increase the efficiency of mass production, the present invention applies sputtering to fabricate multi-layer mirrors, while the scope of applicable materials for multi-layer mirrors is magnified.

### SUMMARY OF THE INVENTION

Accordingly, an object of the invention is to fabricate a multi-layer mirror on a substrate having two adjacent layers of different refractive indices under reactive gases of different concentrations or species.

Therefore, the present invention provides a multi-layer mirror and the fabricating method thereof, applicable for the manufacturing process of micro-cavities in light emitting devices. The method of fabricating the multi-layer mirror comprises sputtering a first-layer mirror with a first refractive index on a transparent substrate of a light-emitting device using a first reactive gas, sputtering a second-layer mirror with a second refractive index using a second reactive gas, and repeating the previous two steps to form a multi-layer mirror having at least two adjacent layers with various refractive indices.

In addition, dependent on the number of layers and the adhesion between the transparent substrate and the multi-layer miror, at least one buffer layer can be coated or sputtered onto the transparent substrate before the deposition of the first-layer mirror to reduce the probability of peeling or degradation of the multi-layer mirror. The buffer layer is, for example, made of a polymer or an inorganic film with high transparency.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a cross-section showing a conventional OLED;

FIG. 2 is a cross-section showing the OLED in the embodiments; and

FIG. 3 is a flow chart showing the fabricating method of multi-layer mirror in the present invention.

### DETAILED DESCRIPTION OF THE INVENTION

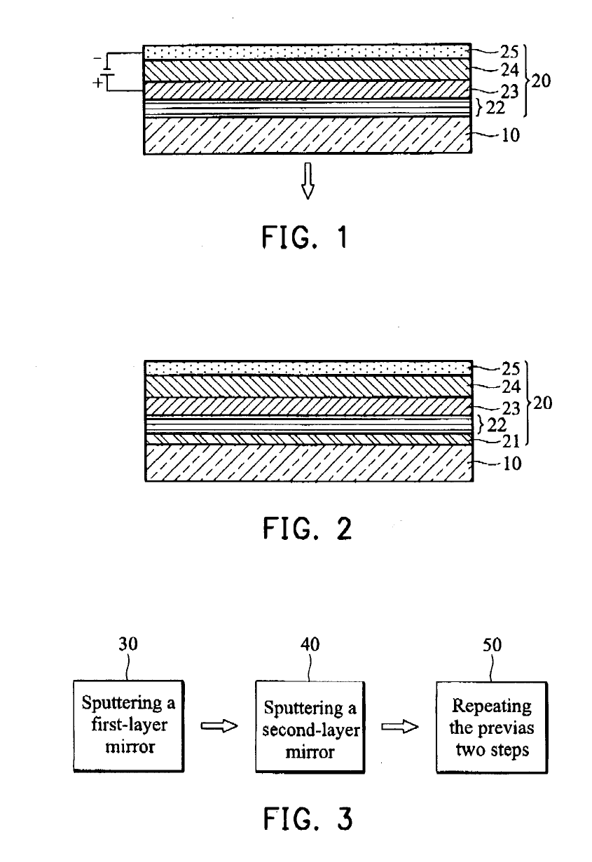

In FIG. 1, a conventional OLED comprises a transparent substrate 10 and a micro-cavity 20. The microcavity 20 is composed of a multi-layer mirror 22, a transparent electrode layer 23, a light emitting layer 24 and a top electrode layer 25 sequentially formed on the transparent substrate 10.

During the operation of the OLTD, an external bias is first applied between the transparent electrode layer 23 and the top electrode layer 25 to inject the holes and electrons from the anode and the cathode, respectively. Under the influence of the electric field, holes and electrons move toward each other and finally meet and combine in the light-emitting layer 24. The current injection through the device excites the electrons to higher energy states, and their relaxation to lower states results in light emission with the wavelengths dependent on the organic materials and device structure used. Meanwhile, dopant emitter materials can be added to increase the light-emitting efficiency and expand the scope of wavelengths of emitted light to all visible light ranges.

According to the manufacturing process in the art, the multi-layer mirror 22 positioned between the transparent substrate 10 and the transparent electrode layer 23 is deposited on the transparent substrate 10 by evaporation to form a multi-layer film with various refractive indices in each layer. By controlling the thickness of the layers and the refractive indices thereof, the optical phase of light of specific wavelength can be shifted and overlapped thereby to result in resonance. By resonance of light, the intensity of three primary colors can be enhanced.

First Embodiment

As in FIG. 2 and FIG. 3, a method of fabricating a multi-layer mirror according to the embodiment comprises sputtering a first-layer mirror 30 and a second-layer mirror 40, and repeating the previous two steps 50 to deposit a multi-layer mirror having at least two adjacent layers with different refractive indices.

In the first step, the target applied is Si, the reactive gas is nitrogen, and RF sputtering on the transparent substrate deposits a SiₓN_{y} film.

In the second step, the reactive gas is changed to oxygen, while the same sputtering system and target as the first step sputter the transparent substrate, depositing a SiOₓ film.

The deposition sequence of the SiₓN_{y} and SiOₓ film is reversible. The thickness of the films must be controlled to around λ/4n, wherein λ is the wavelength of the resonant light, and n is the refractive index of the film.

The transparent substrate 10 can be glass or transparent polymer, for example, polycarbonate. In consideration of the adhesion between the layers, a buffer layer 21 can be spin-coated or sputtered on the transparent substrate 10 prior to the deposition of multi-layer mirrors. The buffer layer 21 can be made of highly-transparent polymer or inorganics. A polymer lacquer (SD-101 or SD-715 manufactured by Japan DIC. Co,) shows improved effect as a buffer layer in mass productive tests of the present invention,

Second Embodiment

As in FIG. 2 and FIG. 3, a method of fabricating a multi-layer mirror according to the embodiment comprises sputtering a first-layer mirror 30, sputtering a second-layer mirror 40, and repeating the previous two steps 50 to deposit a multi-layer mirror having at least two adjacent layers with different refractive indices.

In the first step, the target applied is Si, the reactive gas is oxygen, and RF sputtering on the transparent substrate deposits a SiO₂ film.

In the second step, the reactive gas is changed to oxide of nitrogen (NO), while the same sputtering system and target as the first step sputter the transparent substrate, depositing a SiNₓQ_{y} film. The deposition sequence of the SiO₂ and SiNₓO_{y} film is reversible. The thickness of the films must be controlled to around λ/4n, wherein λ is the wavelength of the resonant light, and n is the refractive index of the film.

For a detailed description of the transparent substrate 10 and buffer layer 21, please refer to the first embodiment.

Third Embodiment

As in FIG. 2 and FIG. 3, a method of fabricating a multi-layer mirror according to the embodiment comprises sputtering a first-layer mirror 30, sputtering a second-layer mirror 40, and repeating the previous two steps 50 to deposit a multi-layer mirror having at least two adjacent layers with different refractive indices.

In the first step, the target applied is Si, the reactive gas is oxygen of a relatively low concentration, and RF sputtering on the transparent substrate deposits a film with a relatively low SiO₂ ratio.

In the second step, the reactive gas is changed to oxygen of a relatively high concentration, while the same sputtering system and target as the first step sputter the transparent substrate, depositing a film with a relatively high Sio₂ ratio.

The above concentration difference in oxygen between two reactive gases is achieved by controlling the gas-inlet rate. The introduction sequence of high/low concentration gases is reversible. The thickness of the films must be controlled to around λ/4n, wherein X is the wavelength of the resonant light, and n is the refractive index of the film.

For a detailed description of the transparent substrate 10 and buffer layer 21, please refer to the first embodiment. The operational radio frequency applied in the above sputtering can be low-frequency modulation (1-200 KHz, for example, between 16-17 KHz) or high-frequency modulation (over 1 MHz).

Fourth Embodiment

The target applicable for the present invention is not limited to Si, but can also be of Zn/Si mixture, Si, Al, Al—Ti alloy, Ti, Ta, Ge, Ge alloy, GaAs, GaInAs, Fe, Bi, Ca, Cd, Ce, Cs, In, Sb—In alloy, Sb, K, La, Li, Mg, Na, Nd, Pt, Pb or Te. The reactive gases introduced can be nitrogen, oxygen, fluorine or any other known reactive gas. A multi-layer mirror having adjacent layers with different refractive indices can be formed by the steps disclosed in the present invention with any of the above-mentioned targets and reactive gases.

According to the present invention, sputtering with the above-mentioned elements creates films that can be deposited on the substrate of ZnS—SiO₂, silicon oxides, silicon oxynitrides, nitrides of Al(for example, AlN), nitrides of Al alloy, oxides of Al (for example, A1203), oxides of Al alloy, titanium nitrides, nitrides of AlTi (AlTiN), TiO₂, Ta₂O₅, nitrides or oxides of Ge, nitrides or oxides of Ge alloy, GaAs, GaInAs, ferric oxides (for example, Fe₂O₃ or Fe₃O₄), bismuth nitrides, oxides or nitrides of Bi(for example, Bi₂O₃), fluorides or oxides of Ca (for example, CaF₂ or CaO), oxides or sulfides of Cd (for example, CdO, Cd2O3 or CdS), oxides or fluorides of Ce (for example, CeO₂ or CeF₂), bromides or iodides of Cs (for example, CsBr or CsI), InAs, InSb alloy, oxides of In (for example, In₂O₂), bromides or chlorides of K (for example, KBr or KCl), fluorides or oxides of La (for example, LaF₃ or La₂O₃), lithium fluoride (for example, LiF), oxides or fluorides of Mg (for example, MgO or MgF₂), sodium fluorides (for example, NaF), oxides or fluorides of Nd (for example, Nd₂O₃, NdF or NdF₃), platinum oxides (for example, PtO₂), oxides or sulfides of Sb (for example, Sb₂O₃ or Sb₂S₃), silicon carbides, and fluorides, chlorides, sulfides, or tellurides of Pb (for example, PbCl₂, PbF₂, PbS or PbTe).

For example, as in FIG. 3, a method of fabricating a multi-layer mirror according to the fourth embodiment comprises sputtering a first-layer mirror 30, sputtering a second-layer mirror 40, and repeating the previous two steps 50 to deposit a multi-layer mirror having at least two adjacent layers with different refractive indices.

In the first step, the target applied is ZnS—SiO₂, and RF sputtering on the transparent substrate deposits a ZnS—SiO₂ film.

In the second step, the target is changed to aluminum nitride (AlN), and RF sputtering on the previously-deposited film deposits a AlN film.

The above concentration difference in oxygen between two reactive gases is achieved by controlling the gas-inlet rate. The introduction sequence of high/low concentration gases is reversible. The thickness of the films must be controlled to around λ/4n, wherein k is the wavelength of the resonant light, and n is the refractive index of the film.

For a detailed description of the transparent substrate 10 and buffer layer 21, please refer to the first embodiment.

According to the method and multi-layer mirrors presented in the above embodiments, by variation of reactive gases, adjustment of flow rate thereof, and selection of targets, mass production of multi-layer mirrors having at least two adjacent layers with different refractive indices is realized. Unlike conventional evaporation, the refractive index of each film in the multi-layer mirror can be adjusted easily by controlling the flow rate or concentration of inlet reactive gases, hence the yield of multi-layer mirrors is increased and manufacturing equipment is simplified.

The foregoing description has been presented for purposes of illustration and description. Obvious modifications or variations are possible in light of the above teaching, The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What in claimed is:

1. A method of fabricating a multi-layer mirror, comprising:
sputtering a first-layer mirror with a first refractive index on a transparent substrate of a light-emitting device using a first reactive gas;
sputtering a second-layer mirror with a second refractive index using a second reactive gas; and
repeating the previous two steps to form a multi-layer mirror having at least two adjacent layers with various refractive indices.

2. The method as claimed in claim 1, wherein the sputtering utilizes a target of Zn/Si mixture, Si, Al, Al—Ti alloy, Ti, Ta, Ge, Ge alloy, GaAs, GaInAs, Fe, Bi, Ca, Cd, Ce, Cs, In, Sb—In alloy, Sb, K, La, Li, Mg, Na, Nd, Pt, Pb or Te.

3. The method as claimed in claim 2, wherein the multi-layer mirror is made of at least two of ZnS—SiO₂, silicon oxides, silicon oxynitrides, nitrides of Al, nitrides of Al alloy, oxides of Al, oxides of Al alloy, titanium nitrides, nitrides of AlTi, TiO₂, Ta₂O₅, nitrides or oxides of Ge, nitrides or oxides of Ge alloy, GaAs, GaInAs, ferric oxides, bismuth nitrides, oxides or nitrides of Bi, fluorides or oxides of Ca, oxides or sulfides of Cd, oxides or fluorides of Ce, bromides or iodides of Cs, InAs, InSb alloy, oxides of In, bromides or chlorides of K, fluorides or oxides of La, lithium fluoride, oxides or fluorides of Mg, sodium fluorides, oxides or fluorides of Nd, platinum oxides, oxides or sulfides of Sb, silicon carbides, and fluorides, chlorides, sulfides, or tellurides of Pb.

4. The method as claimed in claim 1, wherein the target utilized in the sputtering of the first-layer mirror is made of ZnS—SiO₂, and the target utilized in the sputtering of the second-layer mirror is made of AlN.

5. The method as claimed in claim 1, wherein the target utilized in the sputtering of the first-layer mirror is made of AlN, and the target utilized in the sputtering of the second-layer mirror is made of ZnS—SiO₂.

6. The method as claimed in claim 1, wherein the target is made of Si, and the first reactive gas and the second reactive gas are nitrogen and oxygen, respectively.

7. The method as claimed in claim 1, wherein the target is made of Si, and the first reactive gas and the second reactive gas are oxygen and nitrogen, respectively.

8. The method as claimed in claim 1, wherein the target is made of Si, and the first reactive gas and the second reactive gas are oxygen and oxide of nitrogen, respectively.

9. The method as claimed in claim 1, wherein the target is made of Si, and the first reactive gas and the second reactive gas are oxides of nitrogen (NO) and oxygen, respectively.

10. The method as claimed in claim 1, wherein the target is made of Si, and the first reactive gas and the second reactive gas are the same gas of different concentrations.

11. The method as claimed in claim 1, wherein the first reactive gas and the second reactive gas are the same gas injected at two different rates, resulting in two different concentrations.

12. The method as claimed in claim 1, wherein the sputtering is performed on the transparent substrate by a radio frequency (RF) sputtering system.

13. The method as claimed in claim 12, wherein the operational radio frequency of the RF sputtering system is between 1 and 200 KHz.

14. The method as claimed in claim 12, wherein the operational radio frequency of the RF sputtering system is between 16 and 17 KHz.

15. The method as claimed in claim 12, wherein the operational radio frequency of the RF sputtering system is higher than 1 MHz.

16. A multi-layer mirror having at least two adjacent layers with various refractive indices, comprising:
a first-layer mirror with a first refractive index sputtered on a transparent substrate of a light-emitting device using a first reactive gas; and
a second-layer mirror with a second refractive index sputtered using a second reactive gas.

17. The multi-layer mirror as claimed in claim 16, wherein the sputtering utilizes a target of Zn/Si mixture, Si, Al, Al—Ti alloy, Ti, Ta, Ge, Ge alloy, GaAs, GaInAs, Fe, Bi, Ca, Cd, Ce, Cs, In, Sb—In alloy, Sb, K, La, Li, Mg, Na, Nd, Pt, Pb or Te.

18. The multi-layer mirror as claimed in claim 17, wherein the multi-layer mirror is made of at least two of ZnS—SiO₂, silicon oxides, silicon oxynitrides, nitrides of Al, nitrides of Al alloy, oxides of Al, oxides of Al alloy, titanium nitrides, nitrides of AlTi, TiO₂, Ta₂O₅, nitrides or oxides of Ge, nitrides or oxides of Ge alloy, GaAs, GaInAs, ferric oxides, bismuth nitrides, oxides or nitrides of Bi, fluorides or oxides of Ca, oxides or sulfides of Cd, oxides or fluorides of Ce, bromides or iodides of Cs, InAs, InSb alloy, oxides of In, bromides or chlorides of K, fluorides or oxides of La, lithium fluoride, oxides or fluorides of Mg, sodium fluorides, oxides or fluorides of Nd, platinum oxides, oxides or sulfides of Sb, silicon carbides, or fluorides, chlorides, sulfides, or tellurides of Pb.

19. The multi-layer mirror as claimed in claim 16, wherein the target utilized in the sputtering of the first-layer mirror is made of ZnS—SiO₂, and the target utilized in the sputtering of the second-layer mirror is made of AlN.

20. The multi-layer mirror as claimed in claim 16, wherein the target utilized in the sputtering of the first-layer mirror is made of AlN, and the target utilized in the sputtering of the second-layer mirror is made of ZnS—SiO₂.

21. The multi-layer mirror as claimed in claim 16, wherein the target is made of Si, and the first reactive gas and the second reactive gas are nitrogen and oxygen, respectively.

22. The multi-layer mirror as claimed in claim 16, wherein the target is made of Si, and the first reactive gas and the second reactive gas are oxygen and nitrogen, respectively.

23. The multi-layer mirror as claimed in claim 16, wherein the target is made of Si, and the first reactive gas and the second reactive gas are oxygen and oxide of nitrogen (NO), respectively.

24. The multi-layer mirror as claimed in claim 16, wherein the target is made of Si, and the first reactive gas and the second reactive gas are oxides of nitrogen (NO) and oxygen, respectively.

25. The multi-layer mirror as claimed in claim 16, wherein the target is made of Si, and the first reactive gas and the second reactive gas are the same gas of different concentrations.

26. The multi-layer mirror as claimed in claim 16, wherein the first reactive gas and the second reactive gas are the same gas injected at two different rates, resulting in two different concentrations.

27. The multi-layer mirror as claimed in claim 16, wherein the sputtering is performed on the transparent substrate by a radio frequency (RF) sputtering system.

28. The multi-layer mirror as claimed in claim 27, wherein the operational radio frequency of the RF sputtering system is between 1 and 200 KHz.

29. The multi-layer mirror as claimed in claim 27, wherein the operational radio frequency of the RF sputtering system is between 16 and 17 KHz.

30. The multi-layer mirror as claimed in claim 27, wherein the operational radio frequency of the RF sputtering system is higher than 1 MHz.
